(19) United States
(12) Patent Application Publication
(10) Pub. No.: US 2008/0017682 A1
(43) Pub. Date: Jan. 24, 2008

(54) MULTI PURPOSE AUTOMOTIVE TRUNK EXTENSION SYSTEM FOR CARRYING VARIOUS TYPES OF CARGO

(76) Inventors: David A. Warnock, Pertersburg, MI (US); Francois J. Charette, Canton, MI (US)

Correspondence Address: FRANCOIS CHARETTE, 46324 GAINSBOROUGH DRIVE, CANTON, MI, 48187, US

(21) Appl. No.: 11/458,972

(22) Filed: Jul. 20, 2006

(51) Int. Cl. B60R 9/00; B60R 11/00; B60R 7/00

(52) U.S. Cl. 224/492; 224/524; 224/540; 224/556

(57) ABSTRACT

An innovative cargo carrying system specifically designed to be easily mounted at the rear of mid-size or small sedan vehicles that allow easy access to the cargo and has minimal or no effect on wind noise and drag. Mid-size and small sedan vehicles are typically the ones that have the greatest cargo volume limitations and therefore benefit the most of the extra cargo space, especially for long travel. This invention disclosure presents the system and the required hardware needed to attach various types of cargo carrying devices to these vehicles. The system is made of two brackets, a frame and mounts. Various cargo carrying devices can be attached to the frame of this system. Two examples are presented in this invention disclosure, one is a simple platform and the second is an enclosed cargo box that allows locking the cargo and also protects it from the environment.

### FIELD OF THE INVENTION

This invention relates to a cargo carrying system that can easily be mounted on the rear of a vehicle and act as a trunk extension. It is designed to be compact, can be easily installed or removed as needed and does not interfere with the vehicle trunk opening and closing. It allows the user to bring extra cargo with his vehicle, or cargo that simply does not fit in the vehicle trunk.

### BACKGROUND OF THE INVENTION

This invention fills the need to have extra cargo space on a vehicle, more specifically for a mid-size or small car. There are essentially three categories or types of cargo carrier currently available for vehicles. The most common type of cargo carrier for vehicles is based on the design made to be attached directly to a hitch, i.e., act as a hitch extension. There are multiple patents related to this type of cargo carrying device, e.g., U.S. Pat. No. 6,382,486B1, U.S. Pat. Nos. 6,345,749B1, 6,039,227, U.S. Pat. Nos. 6,478,203B2, 5,586,702, 6,145,720, 5,439,151, etc. This type of cargo device is practical only for vehicle equipped with a hitch, which are mainly SUVs and pickups. The second type is the roof mounted ones, e.g., U.S. Pat. No. 6,681,970B2, US2004/0256427A1, etc. These are available for all types of vehicle. Since these are mounted on the roof, it is typically difficult and cumbersome to access the cargo. Also, this type of cargo carrier totally changes the aerodynamic characteristics of the vehicle, which increases drastically the wind noise heard by the vehicle occupants and reduces the fuel economy of the vehicle. The third type attaches directly to the trunk panel, using combination of rubber mounts, clamps and straps, e.g., US2005/0274861A1, US2006/0032879A1, etc. These cargo carrying devices interfere with the closing and opening of the trunk and depending on the weight of the cargo the access to the vehicle trunk can be totally blocked.

The invention presented in this disclosure is original and totally different from the prior art. It takes advantage of the fact that the vast majority of newly designed vehicles, mid-size sedan to small cars, uses a multi links hinge system for their trunk opening that is attached directly on the upper side of the trunk, see FIG. 4. This is in contrast to older designs that mounted the hinge to the front of the trunk. The implementation of this invention uses brackets that are directly bolted to the multi links hinge using the multi links hinge bolts themselves. This implies that there are no vehicle modifications or additional parts required and the only tool needed to attach these brackets is a wrench. A frame is then attached to these brackets using quick connect type attachment commonly use for trailer applications. Finally, various types of cargo carrying devices can be attached to this frame to carry any cargo.

### SUMMARY OF THE INVENTION

This invention presents a multi-purpose automotive trunk extension system that allows carrying extra cargo with a vehicle. In the preferred embodiment disclosed here, the trunk extension system is made of two brackets 11, a frame 10 that attached to the two brackets 11 and three supporting mounts 12 that are between the lower section of the frame and the bumper. Several types of cargo carrying device can then be attached to this frame. Two possible types are presented in this invention disclosure, the first one is a simple platform 13, while the second is an enclosed box 15 in which cargo is protected from the environment and safely secured.

The trunk extension system of this invention is extremely compact, light and versatile. The user can easily remove or replace the cargo carrying device, 13 or 15, without removing the frame 10 from the vehicle. The user can also remove the cargo carrying device and the frame 10, leaving only the brackets 11 in position. These brackets 11 can easily be customized to match the vehicle color, which would make them practically unnoticeable. Furthermore, the system is designed to not interfere with the trunk opening and closing operations, leaving the user easy access to the vehicle trunk area.

### BRIEF DESCRIPTION OF THE DRAWINGS

FIG. 1 is the view showing the three basic components of this invention, the two brackets 11, the frame 10 and the three supporting mounts 12.

FIG. 2 demonstrates one possible implementation of a carrying devise, the flat platform 13.

FIG. 3 demonstrates a second possible implementation of a carrying device, the enclosed cargo box 15.

FIG. 4 shows a detailed view of the right side bracket 11 attached using the multi link hinge bolt.

### DETAILED DESCRIPTION OF THE PREFERRED EMBODIMENT

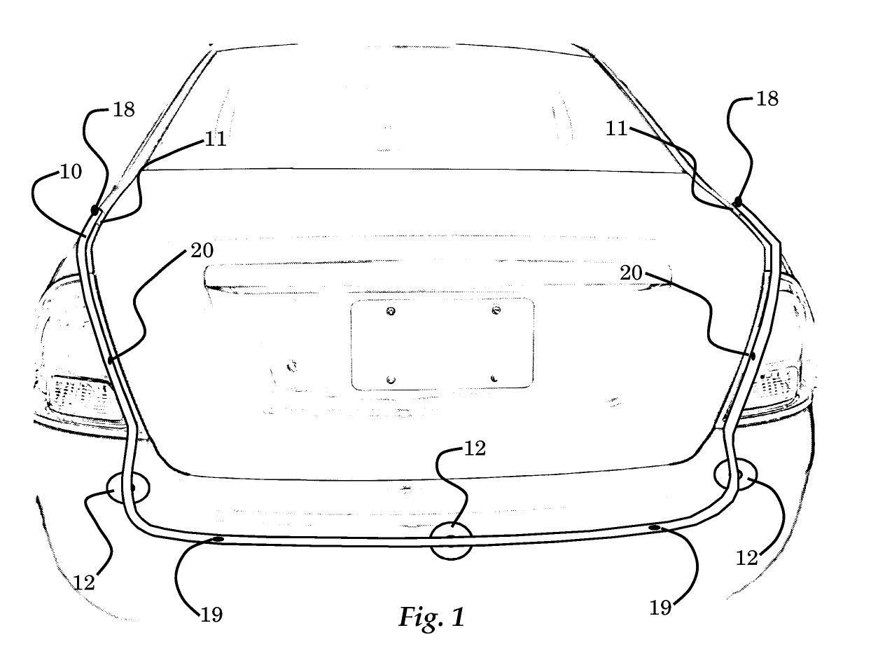

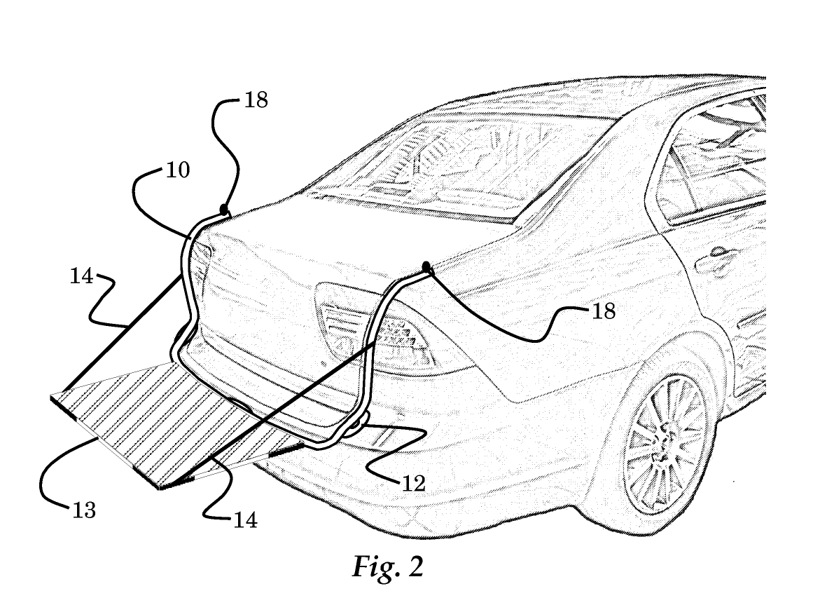

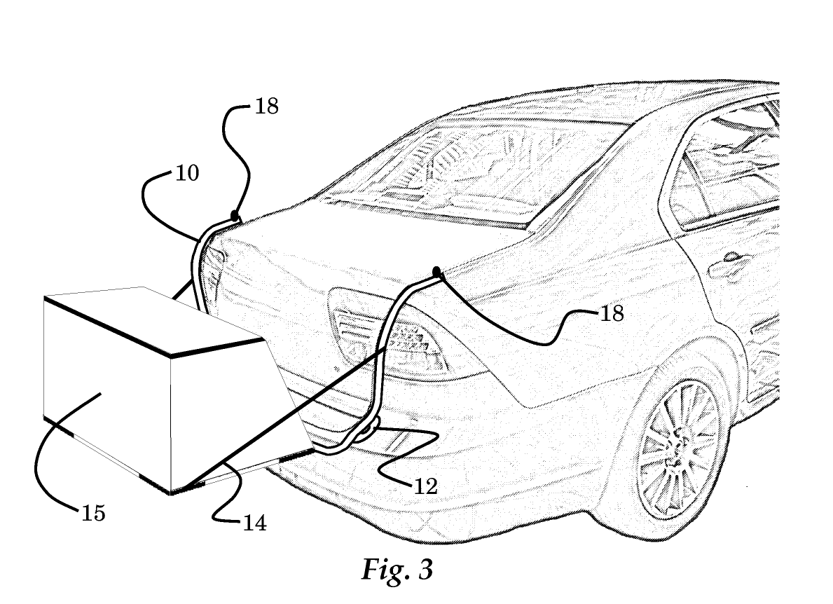

FIGS. 2 and 3 show complete embodiments of this invention. FIG. 1 shows the three basic component of the preferred embodiment that allows attaching varying cargo devices to the vehicle. There are two brackets 11, one on each side of the vehicle. A frame 10 is attached to these brackets using quick connect type attachment 18 typically use in trailer applications. Also attached to the frame 10 are three mounts 12 that transfer weight to the vehicle bumper. In the preferred embodiment, these mounts 12 are suction cups.

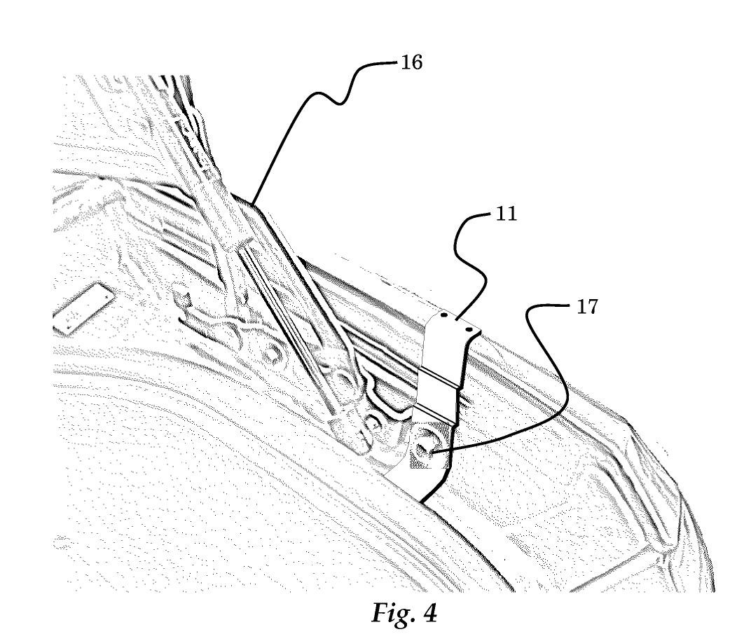

The detailed view of the bracket 11 in FIG. 4 show that it is attached to the vehicle using multi link hinge system bolt 17. These brackets 11 are one of the key elements of this invention disclosure. The brackets 11 are shaped to follow the vehicle body shape all the way down to the horizontal surface of the trench. The brackets 11 thickness is small enough to fit between the opening panel and body of the vehicle without interfering with the opening and closing of the trunk and causing any damages to the vehicle paint. Typically this gap is approximately 3 mm, which means the brackets 11 thickness is about 3 mm or slightly less. Finally, the portion of the brackets 11 that protrudes above the trunk is just long enough to allow attaching the frame to them. The brackets 11 thickness, shape and the multi link hinge bolt 17 provide enough strength to efficiently hold the frame and the attached carrying device.

The frame 10 is made to espouse the exterior of the vehicle body and trunk opening. It does not interfere with the trunk opening and closing operations. In the preferred embodiment, it is made of a round tube. It is well known for somebody skilled in the art that the frame can be made from a tube or beam having any type of cross section, e.g., “I” beam, “U” Beam, square tube, etc. The frame 10 is attached to the brackets using quick connect type coupling attachment 18 commonly available for trailer applications. In the preferred embodiment, the coupling attachment is a hitch pin currently available on the market designed with an integrated spring to prevent squeak and rattles. Again, somebody skilled in the art can replace this particular coupling by any other types of hitch pin or coupling device, including locking ones, or even use a more permanent coupling devices such as bolts and nuts or welding the frame 10 to the brackets 11. The frame 10 also has holes 19 to allow easy attachment of the cargo devices and their supporting arms.

Three mounts 12 are fixed to the frame 10 and allow the frame 10 to rest on the vehicle bumper without any damage to the vehicle. These mounts 12 transfer part of the cargo weight to the vehicle bumper. The brackets 11 function is to help support the cargo load and prevent the frame 10 from pivoting around the mounts 12 when there is a load. In the preferred embodiment, these mounts 12 are rubber suction cups that also help to maintain the frame 10 in position. Somebody who is skilled in the art can replace the suction cups by rubber blocks, shaped Styrofoam blocks, or any other parts made of a material that will transfer the weight of the cargo while protecting the vehicle bumper cover.

The cargo devices, such as platform 13 in FIG. 2 or cargo box 15 in FIG. 3, are secured to the frame 10 by two holes 19 at the bottom of the frame 10 and two side arms 14. The cargo devices have two pins that are located in order to fit in the holes 19 at the bottom of the frame 10. These pins are secured using clips typically use in trailer applications. Similarly, the two side arms 14 have pins that fit in holes 20 along the vertical part of the frame. Again, these are secure using standard clips and pins.

The invention presented in this disclosure is not limited to the preferred embodiment. The invention includes all embodiments that may become apparent after reading this disclosure. Therefore, all implementations that use any variations on the frame 10 cross section shape, coupling devices 18 between the frame 10 and brackets 11, mount designed 12, cargo devices 13 and 15, etc. are implicitly included by this disclosure. If inconsistency between the figures presented and the specification exists, the description in the specification takes precedence over the conflicting information found in the figures.

What is claimed is:

1. Innovative brackets designed to be mounted along the vehicle trunk gap that exists between the trunk opening panel and body of the vehicle.

2. The brackets of claim 1 can be specifically designed to fit exactly on a particular vehicle, following the contours of the vehicle trunk edge.

3. The brackets of claim 1 can have a generic design in order to fit on two or more vehicle lines that have similar trunk shapes and characteristics.

4. Two or more brackets of claim 1 can be used along the trunk opening to attach the frame of the invention.

5. The preferred embodiment show that brackets of claim 1 are mounted on the vehicle using the attachment bolts of the multi link hinge system of the vehicle. No modification to the vehicle is required in that case.

6. The brackets of claim 1 can also be mounted permanently to the vehicle with minor modifications to the vehicle, either by welding or any other type of attachments, e.g., bolts, rivets, etc.

7. The brackets of claim 1 are slim enough to fit between the gap of the trunk panel and the body of the vehicle, approximately 3 mm thick or less.

8. The brackets ends of claim 1 protruding out of the trunk do not interfere with the trunk operations and allows to easily attaching the frame.

9. A frame that attached to the brackets to provide the structures needed to secure various cargo devices.

10. The frame of claim 9 is made of round tube, or any other type of cross section, e.g., square tube, “U” beam, “I” beam, etc.

11. The frame of claim 9 can be specifically designed and shaped for a vehicle line to follow the contours of the vehicle.

12. The frame of claim 9 can have a generic design that fits on two or more vehicle lines that have similar shapes.

13. The frame of claim 9 has holes to secure it on the brackets using pins and clips.

14. The frame of claim 9 has holes on the lower horizontal section to secure the cargo devices.

15. The frame of claim 9 has holes on the vertical section to secure the side supporting arms of the cargo device.

16. Multiple mounts attached to the frame to transfer the weight of the cargo to the vehicle bumpers.

17. The mounts of claim 16 can be suction cups that serve a dual function, transfer the weight of the cargo to the bumper and provide additional fixation of the frame relative to the vehicle.

18. The mounts of claim 16 can be made of rubber or any other materials sufficiently strong to support the weight of the cargo and soft to protect the vehicle.
